(19) United States
(12) Patent Application Publication
(10) Pub. No.: US 2009/0119332 A1
(43) Pub. Date: May 7, 2009

(54) Method And System For Providing A Media Transition Having A Temporal Link To Presentable Media Available From A Remote Content Provider

(76) Inventor: David B. Lection, Raleigh, NC (US)

Correspondence Address: SCENERA RESEARCH, LLC, 111 CORNING RD., SUITE 220, CARY, NC, 27518, US

(21) Appl. No.: 11/933,627

(22) Filed: Nov. 1, 2007

(51) Int. Cl. G06F 7/00

(52) U.S. Cl. 707/104.1; 707/E17.009

(57) ABSTRACT

Methods and systems are described for providing a media transition having a temporal link to presentable media available from a remote content provider. One method includes receiving user input for presenting a media grouping comprising a plurality of media objects including stored media files and a media transition. When the media grouping is presented, the stored media files and the media transition are presented in an interleaved manner. The method further includes receiving an indication that presentable media associated with the media transition is available from a remote content provider, and in response to receiving such an indication, providing in the media transition a temporal link to the presentable media available from the remote content provider. The temporal link is enabled for activation via a user interface only while the media transition is presented so that the associated presentable media is presented when the temporal link is activated.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

The enormous popularity of personal media players is undisputed. Starting with portable tape cassette players and evolving to portable music, audio, video and multimedia players, consumer devices that support these features have provided users with nearly limitless entertainment and connectivity. Typically, a user can download media objects, such as albums, songs, podcasts or video clips, from a compact disk or from a content provider, and group together a plurality of media objects to form one or more playlists. The playlist can define in what order the grouped media objects will be played or presented, or the grouped media objects can be played in a random order.

While the playlist allows the user to create and enjoy a media grouping that includes a plurality of media objects, the playlist does not present additional information beyond the media objects. Indeed, a user who is accustomed to listening to radio feeds for entertainment, might not enjoy listening to the playlist because additional information is not inserted between the media objects of the playlist.

Accordingly, there exists a need for methods, systems, and computer program products for providing a media transition having a temporal link to presentable media available from a remote content provider.

### SUMMARY

Methods and systems are described for providing a media transition having a temporal link to presentable media available from a remote content provider. One method includes receiving user input for presenting a media grouping comprising a plurality of media objects including stored media files and a media transition. When the media grouping is presented, the stored media files and the media transition are presented in an interleaved manner. The method further includes receiving an indication that presentable media associated with the media transition is available from a remote content provider, and in response to receiving such an indication, providing in the media transition a temporal link to the presentable media available from the remote content provider. The temporal link is enabled for activation via a user interface only while the media transition is presented so that the associated presentable media is presented when the temporal link is activated.

In another aspect of the subject matter disclosed herein, a system for providing a media transition having a temporal link to presentable media available from a remote content provider includes means for receiving user input for presenting a media grouping comprising a plurality of media objects including stored media files and a media transition, wherein presenting the media grouping includes presenting the stored media files and the media transition in an interleaved manner, means for receiving an indication that presentable media associated with the media transition is available from a remote content provider, means for providing in the media transition a temporal link to the presentable media available from the remote content provider in response to receiving the indication, and means for enabling the temporal link for activation via a user interface only while the media transition is presented, wherein the associated presentable media is presented when the temporal link is activated.

In another aspect of the subject matter disclosed herein, a system for providing a media transition having a temporal link to presentable media available from a remote content provider is described. The system includes a playlist selection control component configured for receiving user input for presenting a media grouping comprising a plurality of media objects including stored media files and a media transition, wherein presenting the media grouping includes presenting the stored media files and the media transition in an interleaved manner, a transition link processor component configured for receiving an indication that presentable media associated with the media transition is available from a remote content provider and for providing in the media transition a temporal link to the presentable media available from the remote content provider in response to receiving the indication, and a link trigger component configured for enabling the temporal link for activation via a user interface only while the media transition is presented, wherein the associated presentable media is presented when the temporal link is activated.

In another aspect of the subject matter disclosed herein, a computer readable medium containing a computer program, executable by a machine, for providing a media transition having a temporal link to presentable media available from a remote content provider includes instructions for receiving user input for presenting a media grouping comprising a plurality of media objects including stored media files and a media transition, wherein presenting the media grouping includes presenting the stored media files and the media transition in an interleaved manner, for receiving an indication that presentable media associated with the media transition is available from a remote content provider, for providing in the media transition a temporal link to the presentable media available from the remote content provider in response to receiving the indication, and for enabling the temporal link for activation via a user interface only while the media transition is presented, wherein the associated presentable media is presented when the temporal link is activated.

### BRIEF DESCRIPTION OF THE DRAWINGS

Objects and advantages of the present invention will become apparent to those skilled in the art upon reading this description in conjunction with the accompanying drawings, in which like reference numerals have been used to designate like elements, and in which:

FIG. 1 is a block diagram illustrating an arrangement that includes a system for providing a media transition having a temporal link to presentable media available from a remote content provider according to an exemplary embodiment;

FIG. 2 is a block diagram illustrating an exemplary multimedia player that includes a system for providing a media transition having a temporal link to presentable media available from a remote content provider according to an exemplary embodiment;

FIG. 3 is a flowchart illustrating a method for providing a media transition having a temporal link to presentable media available from a remote content provider according to an exemplary embodiment;

FIG. 4 is illustrates an exemplary playlist that includes media transitions according to an exemplary embodiment; and

FIGS. 5A-5C show exemplary presentation windows according to an exemplary embodiment.

### DETAILED DESCRIPTION

Methods, systems, and computer program products for providing a media transition having a temporal link to presentable media available from a remote content provider are disclosed. According to one embodiment, a media grouping comprising a plurality of media objects includes stored media files and media transitions. When presented, the media transitions and stored media files, e.g., songs, are played in an interleaved manner, i.e., the media transitions are played between the songs on the playlist. In one embodiment, the media transition can be associated with presentable media available over a network from a remote content provider. The presentable media can be static as well as dynamic. For example, the presentable media can be a news update from an online news service or a weather report from an online weather service. Depending on the playlist, the media transitions can be scheduled to be played between a specified number of stored media files or at specified time intervals.

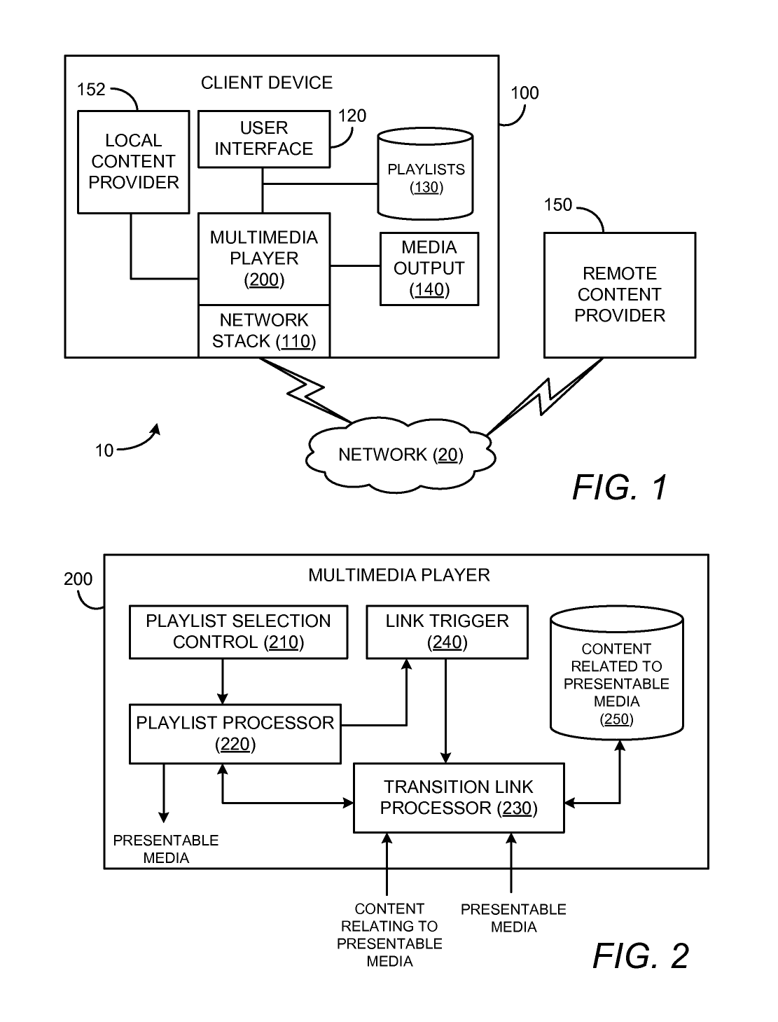

FIG. 1 is a block diagram illustrating an arrangement that includes a system for providing a media transition having a temporal link to presentable media available from a remote content provider according to one embodiment. The arrangement 10 includes a client device 100 communicatively coupled to a remote content provider 150 via a network 20. The network 20 may be a Local Area Network (LAN) and/or a Wide Area Network (WAN) including the Internet, and the client device 100 can be communicatively coupled to the network 20 via a wired or wireless connection. In one embodiment, the client device 100 is configured to send requests for and/or to receive content from the remote content provider 150 over the network 20.

The client device 100, in one embodiment, includes a multimedia player component 200 for presenting a plurality of media objects in a playlist 130 stored locally, as shown, or remotely. The multimedia player component 200 can operate as an application in an execution environment of the client device 100. The execution environment can be any processing environment configured to support the operation of the multimedia player component 200. For example, the execution environment can include an operating system, a processor, and various other hardware and/or software components required by the multimedia player component 200.

The client device 100 includes a media output component 140 operatively coupled to the multimedia player component 200. The media output component 140 can be configured to present the media objects. In one embodiment, the media output component 140 can include a media decoder (not shown) for decoding media objects received from the multimedia player component 200 and an audio amplifier (not shown) for receiving the decoded media objects and amplifying the audio signal so that it can be presented on headphones or speakers (not shown).

According to an exemplary embodiment, the multimedia player component 200 is configured to receive via a user interface 120 an indication selecting one of a plurality of playlists 130 and to retrieve the selected playlist 130. In one embodiment, the playlist 130 includes instructions for presenting a media grouping comprising a plurality of media objects that include stored media files. The stored media files can be a predetermined collection of songs, e.g., an album, or a plurality of discrete media files. In addition, the playlist 130 includes instructions for presenting interstitial media objects between the stored media files. These interstitial media objects are referred to as media transitions. Accordingly, when the multimedia player component 200 executes the playlist 130 instructions, the stored media files and the media transitions of the media grouping are presented in an interleaved manner. In other words, the stored media files and the media transitions are presented without one interrupting or truncating the other.

According to one embodiment, the playlist 130 can be generated locally by the client 100, or remotely by a playlist application (not shown) in a standalone computer system (not shown) and imported into the client device 100, e.g., when the client device 100 docks to the computer system. When a playlist 130 is generated, the stored media files are identified, and the media transitions can be identified from a plurality of media transitions.

When the stored files and media transitions are identified, the order in which the media objects will be presented can be determined. In one embodiment, the placement or scheduling of the media transitions can be based on a time, e.g., at or near noon; a time period, e.g., every 15 minutes; and/or a number of stored media files presented, e.g., after every two songs. For example, a TIME ANNOUNCE media transition that announces the current time can be configured to play one time at the beginning of the playlist 130, but through preferences associated with the media transition, the time can also be announced every 15 minutes. Thus, for example, when more than 15 minutes have passed since the last time announce, the TIME ANNOUNCE media transition can be dynamically inserted after a current media object and the time can be announced after the completion of the current media object. Accordingly, the TIME ANNOUNCE media transition can be played in between two stored media files, as well as before or after another media transition.

In addition, a media transition can be scheduled to be presented in response to an indication of an event. For example, when the client device 100 receives an asynchronous or synchronous notification message relating to an emergency or phone call from a particular user, a media transition associated with the event can be inserted after the current media object and the content of the event can be presented after the completion of the current media object.

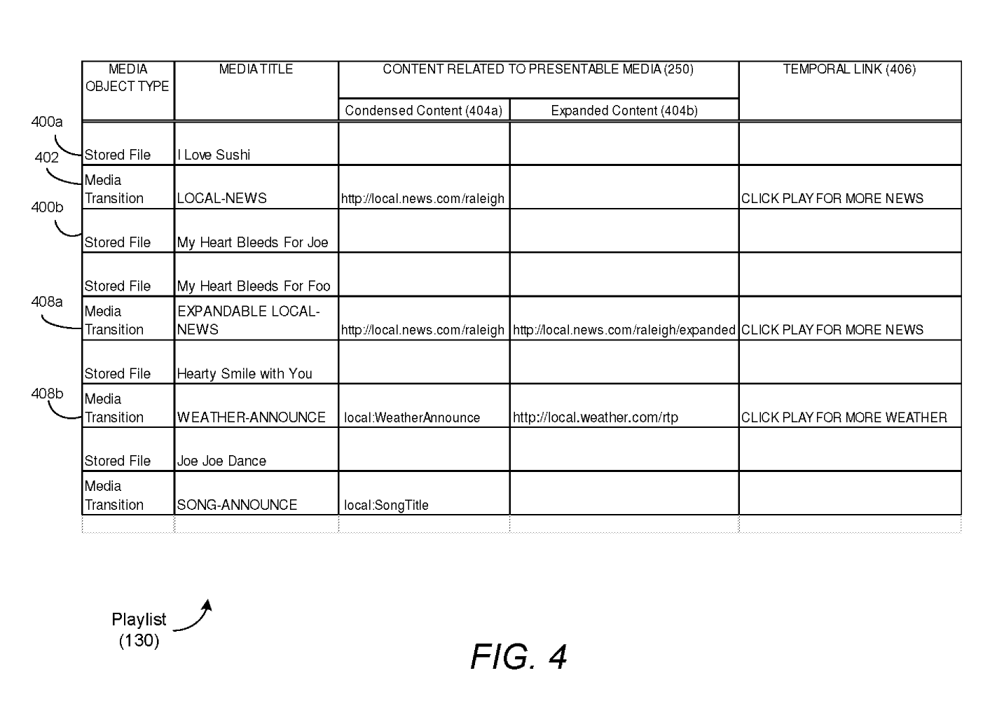

When the stored files and media transitions are identified and the order in which the media objects will be presented is determined, the ordered media objects are associated with the media grouping, and instructions for presenting the media grouping are generated and associated with the playlist 130. FIG. 4 is a schematic illustration of an exemplary playlist 130 according to one embodiment. In this example, the playlist 130 includes instructions for presenting a first song (400a), entitled “I Love Sushi,” followed by a LOCAL NEWS media transition (402), and followed by a second song (400b), entitled “My Heart Bleeds for Joe.” The playlist 130 can be stored, in one embodiment, in a local data store, as shown in FIG. 1, or in a remote server (not shown) accessible via the network 20.

In one embodiment, media transitions can be associated with presentable media available from local content providers 152, such as application programs in the client device 100. For example, a local time clock (not shown) and a media identifier tag processor application (not shown) can be local content providers 152 that provide the time of day and the name of a song to be played next, respectively. In addition, a calendaring application can be a local content provider 152 that provides upcoming appointments/meetings scheduled for a particular hour.

In addition, media transitions can be associated with presentable media available from the remote content provider 150. In this case, the multimedia player component 200 is configured to associate a temporal link with the presentable media. When the media transition is presented, e.g., between two stored media files, the multimedia player component 200 enables and displays the temporal link to the user via the user interface 120. When the user activates the temporal link, the associated presentable media can be retrieved and presented via the media output component 140. In this manner, timely and dynamic content can be interspersed with static content so that the user can stay informed of developing events while enjoying stored content.

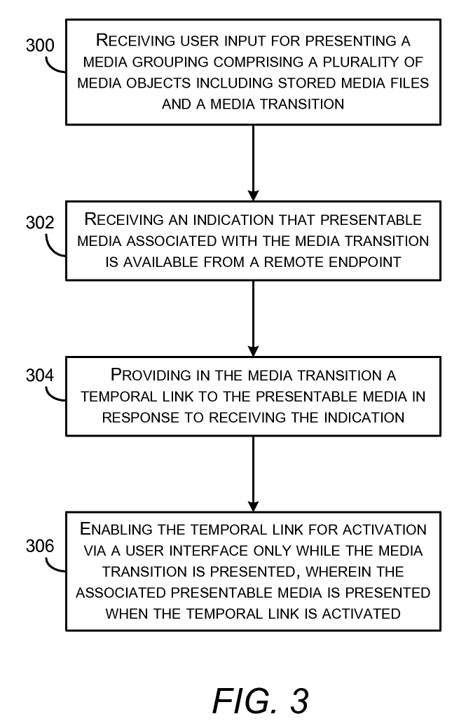

To describe with more particularity the functionality of the multimedia player component 200, reference to FIG. 2 and FIG. 3 is made. FIG. 2 is block diagram illustrating the multimedia player component 200 in more detail according to an exemplary embodiment, and FIG. 3 is a flowchart illustrating an exemplary method for providing a media transition having a temporal link to presentable media available from a remote content provider according to one embodiment.

Referring to FIG. 1, FIG. 2 and FIG. 3, the exemplary method begins when the multimedia player component 200 receives user input for presenting a media grouping comprising a plurality of media objects including stored media files and a media transition (block 300). According to an exemplary embodiment, the multimedia player component 200 includes means for receiving user input for presenting a media grouping comprising a plurality of media objects including stored media files and a media transition. For example, a playlist selection control component 210 in the multimedia player component 200 can be configured to perform this function.

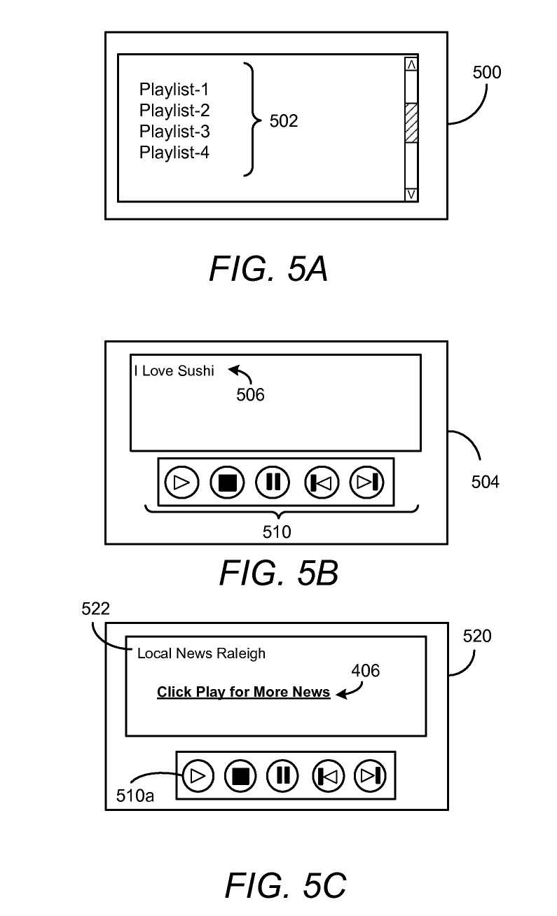

According to an exemplary embodiment, the playlist selection control component 210 can present, via the user interface 120, a plurality of playlists 130 corresponding to a plurality of media groupings from which a user can choose. FIG. 5A depicts an exemplary window 500 presented by the playlist selection control component 210 on the user interface 120. The window 500 includes a list 502 of playlists that can be selected. The playlist selection control component 210 implements the window 500 and processes user inputs for the scrolling through the list 502, and for selecting a playlist 130. For example, the user can scroll the list 502 of playlist titles using the scroll bar, and can click on a playlist title to select the corresponding playlist 130.

When the playlist selection control component 210 receives the user input selecting the media grouping, it is configured to retrieve, in one embodiment, the corresponding playlist 130 from storage. According to an exemplary embodiment, a playlist processor component 220 operatively coupled to the playlist selection control component 210 can be configured to process and execute the instructions in the retrieved playlist 130. In one embodiment, the playlist processor component 220 is configured to retrieve and analyze the media objects, e.g., the stored media files and the media transitions, of the media grouping pursuant to the playlist 130 instructions.

When it is determined that a media object is a media transition and that the presentable media associated with the media transition is available from the remote content provider 150, the playlist processor component 220, in one embodiment, can invoke a transition link processor component 230 to request content related to the presentable media from the remote content provider 150. For example, the transition link processor component 230 can be configured to send an HTTP request for the content to the remote content provider 150 using the network stack component 110. In one embodiment, the requested content can include a file, e.g., an MP3 file, or an MPEG video file, and/or a media item link associated with a live stream of media content.

Referring again to FIG. 3, the exemplary method includes receiving an indication that presentable media associated with the media transition is available from a remote content provider 150 is received (block 302). According to an exemplary embodiment, the multimedia player component 200 includes means for receiving the indication that presentable media associated with the media transition is available from the remote content provider 150. For example, the transition link processor component 230 can be configured to perform this function.

According to one embodiment, in response to the request for content related to the presentable media, the remote content provider 150 returns the content to the transition link processor component 230, which is configured to receive and store the content 250 in a local or remote data store. By receiving the content, the transition link processor component 230 receives the indication that presentable media associated with the media transition is available.

In response to receiving such an indication, a temporal link to the presentable media available from the remote content provider 150 is provided in the media transition (block 304). According to one embodiment, the multimedia player component 200 includes means for providing in the media transition a temporal link to the presentable media available from the remote content provider 150. For example, the transition link processor component 230 can be configured for performing this function.

According to an exemplary embodiment, the temporal link can be a phrase or word that is associated with the requested/received content related to the presentable media. For example, in FIG. 4, the requested content 404 related to presentable media 404 associated with the LOCAL NEWS media transition (402) can be associated with the temporal link (406), “Click Play for More News.” In one embodiment, the temporal link 406 can be supplied by the remote content provider 150 when it returns the content related to the presentable media 250. In another embodiment, the transition link processor component 230 can supply the temporal link 406 based on the media transition (402). The media transition 402 and the temporal link 406 can be stored separately or along with the requested content 404.

When the playlist processor component 220 has processed the media objects in the media grouping, the media grouping can be presented in order. For instance, referring to the playlist 130 in FIG. 4, the first media object to be presented is a stored media file 400a. The playlist processor component 220 can retrieve the stored media file 400a from a local or remote data store (not shown) and send the stored media file 400a to the media output component 140 for decoding and playback.

While the first media object 400a is being played, the playlist processor component 220 can present, via the user interface 120, a presentation window such as that depicted in FIG. 5B. In one embodiment, the presentation window 504 can include a media object identifier (506), e.g., the media title that identifies the media object currently being played. Other items may be displayed in the presentation window 504 as well, such as the playlist title, the number of selections in the playlist 130, a battery level, and a time of day. In one embodiment, the presentation window 504 can include an array of pushbutton components 510 that manage the functions of navigating and playing the list of selections in the playlist 130. These functions include play, stop, pause, skip to next selection, and skip to previous selection.

While the current media object is being played, the playlist processor component 220 can begin processing the next media object in the playlist 130, which can be another stored file, or a media transition. According to one embodiment, when the media object is a media transition, the playlist processor component 220 can retrieve and present the media transition after the current media object.

In one embodiment, when the presentable media associated with a media transition is provided by a local content provider 152, e.g., a local time clock, the playlist processor component 220 can invoke the transition link processor component 230. The transition link processor component 230, in one embodiment, is configured to retrieve the presentable media directly from the local content provider 152 so that the retrieved presentable media can be automatically presented when the associated media transition 402 is presented. For example, referring again to FIG. 4, the playlist 130 includes a SONG ANNOUNCE media transition that is associated with presentable media provided by a local content provider 152 designated by “local:SongTitle.” The transition link processor component 230 can call the local content provider 152 directly and retrieve the name of the previous or next song so that it can be presented during the media transition.

In another embodiment, the presentable media associated with the media transition is provided by the remote content provider 150. For example, in the playlist 130 in FIG. 4, the LOCAL NEWS media transition (402) is associated with presentable media available from a remote content provider 150. In this case, the playlist processor component 220 presents the media transition. While the media transition is presented, the temporal link is enabled for activation via the user interface 120 such that the associated presentable media is presented when the temporal link 406 is activated (block 306). According to one embodiment, the multimedia player component 200 includes means for enabling the temporal link for activation via a user interface only while the media transition is presented. For example, a link trigger component 240 can be configured to perform this function.

According to one embodiment, while the media transition, e.g., the LOCAL NEWS media transition 402, is being played, the playlist processor component 220 can present, via the user interface 120, a transition presentation window such as that depicted in FIG. 5C. The transition presentation window 520 includes the temporal link 406 associated with the content relating to the presentable media 250 and can include a media transition identifier (522), as well as other information described above. In one embodiment, the playlist processor component 220 invokes the link trigger component 240, which enables the temporal link 406 presented in the media presentation window 520. Accordingly, the temporal link 406 is enabled for activation only while the media transition 420 is being presented via the user interface 120.

According to an exemplary embodiment, the link trigger component 240 is configured to receive, via the user interface 120, an input for activating the temporal link 406 when the media transition 402 is presented. For example, when the user clicks on a pushbutton component 510a that corresponds to a play function in the media presentation window 520, the link trigger component 240 receives this command and associates it with an activation of the temporal link 406. In response to receiving the activation input, the link trigger component 240 can invoke the transition link processor component 230, in one embodiment, to present the presentable media associated with the media transition 402 and provided by the remote content provider 150.

In one embodiment, when so invoked, the transition link processor 230 is configured to retrieve the content related to the presentable media 250 associated with the media transition 402. Content 250 provided by the remote content provider 150 can include a file and/or a media item link associated with a live stream of media content. When the content 250 is a stored file, e.g., MP3 file or MPEG audio/video file, the transition link processor 230 can retrieve the stored file and return it to the playlist processor component 220, which sends the file to the media output component 140 for decoding and playback. Alternatively, or in addition, when the content 150 is a media item link, e.g., a URL, the transition link processor component 230 can use the media item link to request and receive the live stream of media content from the remote content provider 150 over the network 20 via the network stack 110. When received, the transition link processor component 230 can pass the live stream of media content to the playlist processor component 220, which sends the stream to the media output component 140 for decoding and playback.

According to another embodiment, the media transition can be associated with presentable media available from the remote content provider 150 that includes a condensed media object that is automatically presented when the media transition is presented and an expanded media object related to the condensed media object that is presented only when a temporal link associated with the expanded media object is activated. In this instance, when the transition link processor component 230 receives the content related to the presentable media 250 from the remote content provider 150, the received content can include condensed content corresponding to the condensed media object and expanded content corresponding to the expanded media object. The temporal link 406 can be associated only with the expanded content and can be enabled only when the associated media transition is presented.

For example, referring again to FIG. 4, an EXPANDABLE LOCAL NEWS media transition 408a is associated with condensed content 404a and expanded content 404b. In one embodiment, the condensed content 404a can be a first URL and the expanded content 404b can be a second URL. In this case, when the EXPANDABLE LOCAL NEWS media transition 408a is presented, the condensed content 404a, e.g., the first URL, is used to retrieve the condensed media object from the remote content provider 150 and is automatically presented to the user. While the condensed media object is being presented, the enabled temporal link 406 can be activated by the user and the expanded content 404b, e.g., the second URL, can be used to retrieve the expanded media object for presentation to the user pursuant to the user's request.

In another example, a WEATHER ANNOUNCE media transition 408b can be associated with condensed content 404a related to content provided by a local content provider 152 and expanded content 404b related to content provided by a remote content provider 150. In other embodiments, the condensed content 404a of a media transition can correspond to a stored file and the expanded content 404b can be a URL for live stream content from the remote content provider 150. Clearly, the presentable media associated with media transitions can be broad and varied, and the examples described above are not exhaustive.

According to an exemplary embodiment, when the presentable media associated with a media transition is presented, e.g., when the user activates the temporal link 406, presentation of the subsequent media objects in the playlist 130 is suspended. Upon completion of the playback of the media transition 402, the playlist resumes playback. For example, referring again to the playlist 130 in FIG. 4, the song “Hearty Smile with You” will begin playback upon completion of the presentable media associated with the EXPANDABLE LOCAL NEWS media transition 408a.

Through aspects of the embodiments described, a playlist for a multimedia player component 200 includes stored media files and media transitions that are presented in an interleaved manner. In an exemplary embodiment, a media transition can be associated with presentable media from a remote content provider 150. When the multimedia player component 200 is presenting the media transition, a temporal link to the presentable media is enabled for activation so that the presentable media is presented when the temporal link is activated. In this manner, presentable media that is timely and dynamic can be interspersed with static content so that the user can stay informed of developing events while enjoying stored content.

It should be understood that the various components illustrated in the figures represent logical components that are configured to perform the functionality described herein and may be implemented in software, hardware, or a combination of the two. Moreover, some or all of these logical components may be combined and some may be omitted altogether while still achieving the functionality described herein.

To facilitate an understanding of exemplary embodiments, many aspects are described in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both.

Moreover, the sequences of actions can be embodied in any computer-readable medium for use by or in connection with an instruction execution system, apparatus, or device, such as a computer-based system, processor containing system, or other system that can fetch the instructions from a computer-readable medium and execute the instructions.

As used herein, a “computer-readable medium” can be any medium that can contain, store, communicate, propagate, or transport instructions for use by or in connection with the instruction execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a portable digital video disc (DVD), a wired network connection and associated transmission medium, such as an ETHERNET transmission system, and/or a wireless network connection and associated transmission medium, such as an IEEE 802.11(a), (b), or (g) or a BLUETOOTH transmission system, a wide-area network (WAN), a local-area network (LAN), the Internet, and/or an intranet.

Thus, the subject matter described herein can be embodied in many different forms, and all such forms are contemplated to be within the scope of what is claimed.

It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for providing a media transition having a temporal link to presentable media available from a remote content provider, the method comprising:
receiving user input for presenting a media grouping comprising a plurality of media objects including stored media files and a media transition, wherein presenting the media grouping includes presenting the stored media files and the media transition in an interleaved manner;
receiving an indication that presentable media associated with the media transition is available from a remote content provider;
in response to receiving the indication, providing in the media transition a temporal link to the presentable media available from the remote content provider; and
enabling the temporal link for activation via a user interface only while the media transition is presented, wherein the associated presentable media is presented when the temporal link is activated.

2. The method of claim 1 further comprising configuring the media grouping, wherein configuring includes:
identifying at least one of a predetermined collection of media files and a plurality of discrete media files;
identifying the media transition from a plurality of media transitions;
determining in what order to present the media files and media transition; and
associating the ordered selected media files and the media transition with the media grouping.

3. The method of claim 2 wherein determining in what order to present the media files and media transition includes scheduling the presentation of the media transition based on at least one of a time, a time period, a number of media files presented, and an indication of an event.

4. The method of claim 1 wherein after user input is received for presenting the media group, the method includes:
retrieving and analyzing a media object in the media grouping;
determining that the media object is the media transition;
requesting content relating to the presentable media from the remote content provider, wherein the content includes at least one of a file and a media item link, the media item link associated with a live stream of media content; and
receiving and storing the content relating to the presentable media.

5. The method of claim 4 wherein receiving the indication that presentable media associated with the media transition is available includes receiving the requested content from the remote content provider.

6. The method of claim 4 wherein providing the temporal link includes associating the temporal link with the requested content.

7. The method of claim 6 further comprising:
receiving, via the user interface, an input for activating the temporal link when the transition is presented;
in response to receiving the activation input, at least one of retrieving the stored file when the requested content is a stored file and using the media item link to receive the live stream of media content from the remote content provider when the requested content is a stored media item link; and
presenting at least one of the stored file and the live stream of media content.

8. The method of claim 1 further comprising:
receiving, via the user interface, an input for activating the temporal link when the media transition is presented; and
in response to receiving the activation input, presenting the associated presentable media from the remote content provider, wherein while the presentable media is presented, presentation of subsequent media objects of the media grouping is suspended.

9. The method of claim 1 wherein the media transition is associated with presentable media available from a local content provider and wherein the method further includes retrieving the presentable media available from the local content provider and automatically presenting the retrieved presentable media when the media transition is presented.

10. The method of claim 1 wherein the presentable media available from a remote content provider includes a condensed media object and an expanded media object related to the condensed media object and wherein the method further includes receiving the condensed media object and the expanded media object from the remote content provider; providing in the media transition a temporal link to the expanded media object, and automatically presenting the retrieved condensed media object and enabling the temporal link when the media transition is presented.

11. A system for providing a media transition having a temporal link to presentable media available from a remote content provider, the system including:
a playlist selection control component configured for receiving user input for presenting a media grouping comprising a plurality of media objects including stored media files and a media transition, wherein presenting the media grouping includes presenting the stored media files and the media transition in an interleaved manner;
a transition link processor component configured for receiving an indication that presentable media associated with the media transition is available from a remote content provider and for providing in the media transition a temporal link to the presentable media available from the remote content provider in response to receiving the indication; and
a link trigger component configured for enabling the temporal link for activation via a user interface only while the media transition is presented, wherein the associated presentable media is presented when the temporal link is activated.

12. The system of claim 11, wherein the media grouping is generated by identifying at least one of a predetermined collection of media files and a plurality of discrete media files, by identifying the media transition from a plurality of media transitions, by determining in what order to present the media files and media transition, and by associating the ordered selected media files and the media transition with the media grouping.

13. The system of claim 12 wherein the scheduling of the presentation of the media transition is based on at least one of a time, a time period, a number of media files presented, and an indication of an event.

14. The system of claim 11 further comprising a playlist processor component configured for retrieving and analyzing a media object in the media grouping, and for determining that the media object is the media transition, and wherein the transition link processor component is configured for requesting content relating to the presentable media from the remote content provider, wherein the content includes at least one of a file and a media item link, the media item link associated with a live stream of media content, and for receiving and storing the content relating to the presentable media.

15. The system of claim 14 wherein the transition link processor component is configured for associating the temporal link with the requested content.

16. The system of claim 15 wherein the link trigger component is configured for receiving, via the user interface, an input for activating the temporal link when the transition is presented, and wherein the transition link processor component is configured for at least one of retrieving the stored file when the requested content is a stored file and using the media item link to receive the live stream of media content from the remote content provider when the requested content is a stored media item link, and for presenting at least one of the stored file and the live stream of media content.

17. The system of claim 11 wherein the link trigger component is configured for receiving, via the user interface, an input for activating the temporal link when the media transition is presented, and the transition link processor component is configured for presenting the associated presentable media from the remote content provider, wherein while the presentable media is presented, presentation of subsequent media objects of the media grouping is suspended.

18. The system of claim 11 wherein the media transition is associated with presentable media available from a local content provider and wherein the transition link processor component is configured for retrieving the presentable media available from the local content provider and automatically presenting the retrieved presentable media when the media transition is presented.

19. The system of claim 11 wherein the presentable media available from a remote content provider includes a condensed media object and an expanded media object related to the condensed media object and wherein the transition link processor component is configured for receiving the condensed media object and the expanded media object from the remote content provider, for providing in the media transition a temporal link to the expanded media object, and for automatically presenting the retrieved condensed media object and enabling the temporal link when the media transition is presented.

20. A system for providing a media transition having a temporal link to presentable media available from a remote content provider, the system including:
means for receiving user input for presenting a media grouping comprising a plurality of media objects including stored media files and a media transition, wherein presenting the media grouping includes presenting the stored media files and the media transition in an interleaved manner;
means for receiving an indication that presentable media associated with the media transition is available from a remote content provider;
means for providing in the media transition a temporal link to the presentable media available from the remote content provider in response to receiving the indication; and
means for enabling the temporal link for activation via a user interface only while the media transition is presented, wherein the associated presentable media is presented when the temporal link is activated.

21. A computer readable medium embodying a computer program, executable by a machine, for providing a media transition having a temporal link to presentable media available from a remote content provider, the computer program comprising executable instructions for:
receiving user input for presenting a media grouping comprising a plurality of media objects including stored media files and a media transition, wherein presenting the media grouping includes presenting the stored media files and the media transition in an interleaved manner;
receiving an indication that presentable media associated with the media transition is available from a remote content provider;
providing in the media transition a temporal link to the presentable media available from the remote content provider in response to receiving the indication; and
enabling the temporal link for activation via a user interface only while the media transition is presented, wherein the associated presentable media is presented when the temporal link is activated.
